(19) United States
(12) Patent Application Publication
(10) Pub. No.: US 2024/0352284 A1
(43) Pub. Date: Oct. 24, 2024

(54) ADHESIVE SHEET AND ADHESIVE SHEET MANUFACTURING METHOD

(71) Applicant: LINTEC CORPORATION, Tokyo (JP)

(72) Inventors: Sho KOSABA, Tokyo (JP); Takayuki ARAI, Tokyo (JP); Mikihiro KASHIO, Tokyo (JP); Yoshinori TAKASHIMA, Osaka (JP); Akira HARADA, Osaka (JP)

(73) Assignee: LINTEC CORPORATION, Tokyo (JP)

(21) Appl. No.: 18/294,790

(22) PCT Filed: Aug. 4, 2021
(86) PCT No.: PCT/JP2021/029012

§ 371 Date: Feb. 2, 2024

(51) Int. Cl. C09J 7/38; C09J 133/08

(52) U.S. Cl. CPC C09J 7/385; C09J 133/08; C09J 2301/302; C09J 2301/312; C09J 2301/414; C09J 2301/416; C09J 2301/50; C09J 2400/143

(57) ABSTRACT

A pressure sensitive adhesive sheet includes at least a pressure sensitive adhesive layer, wherein the gel fraction of a pressure sensitive adhesive that constitutes the pressure sensitive adhesive layer is less than 10%, and the 500% modulus when performing a tensile test at 23° C. for the pressure sensitive adhesive layer is 0.02 N/mm² or more and 5 N/mm² or less. In the pressure sensitive adhesive sheet, the pressure sensitive adhesive that constitutes the pressure sensitive adhesive layer may contain a polymer having a main chain obtained by copolymerizing an acrylic-based monomer and a cyclodextrin derivative having a polymerizable group. Such a pressure sensitive adhesive sheet enables the pressure sensitive adhesive layer to be recycled.

### TECHNICAL FIELD

The present invention relates to a pressure sensitive adhesive sheet and a method of manufacturing the pressure sensitive adhesive sheet and more particularly to a recyclable pressure sensitive adhesive sheet and a method of manufacturing the pressure sensitive adhesive sheet.

### BACKGROUND ART

In recent years, there has been a growing demand for establishing a recycling-based society, and various products and materials are required to be recyclable.

Most recently, novel materials using cyclodextrin monomers have been proposed. Specifically, Patent Document 1 proposes a polymer material that contains a crosslinked polymer obtained by being crosslinked as a result of an interaction between a host group and a guest group. The host group is a monovalent group obtained by removing one hydrogen atom or one hydroxyl group from cyclodextrin. The above crosslinked polymer includes a predetermined repeating structural unit.

Patent Document 2 proposes an inclusion complex that is formed from the host group of a host group-containing monomer and the guest group of a guest group-containing monomer. The host group-containing monomer is a cyclodextrin monomer derivative having a (meth)acryloyl group. The guest group-containing monomer is a predetermined monomer having a vinyl group.

### PRIOR ART DOCUMENTS

### Patent Documents

[Patent Document 1] JP6636610B
[Patent Document 2] JP6239043B

### SUMMARY OF THE INVENTION

### Problems to be Solved by the Invention

From the previously described background, it is desirable that the pressure sensitive adhesive layer of a pressure sensitive adhesive sheet can also be recycled. Note, however, that none of Patent Documents 1 and 2 describes the pressure sensitive adhesive layer of a pressure sensitive adhesive sheet or mentions anything about the recyclability.

The present invention has been made in view of such actual circumstances as above, and an object of the present invention is to provide a pressure sensitive adhesive sheet whose pressure sensitive adhesive layer can be recycled and a method of manufacturing the pressure sensitive adhesive sheet.

### Means for Solving the Problems

To achieve the above object, first, the present invention provides a pressure sensitive adhesive sheet comprising at least a pressure sensitive adhesive layer, wherein the gel fraction of a pressure sensitive adhesive that constitutes the pressure sensitive adhesive layer is less than 10%, and the 500% modulus when performing a tensile test at 23° C. for the pressure sensitive adhesive layer is 0.02 N/mm² or more and 5 N/mm² or less (Invention 1).

In the above invention (Invention 1), the pressure sensitive adhesive layer having the above physical properties is excellent in the recyclability. Specifically, the recoverability after dissolving in a solvent or the like is excellent, and the pressure sensitive adhesive layer can be re-formed from a pressure sensitive adhesive solution obtained by dissolving in a solvent or the like. The re-formed pressure sensitive adhesive layer can then exhibit an adhesive strength close to that of the original pressure sensitive adhesive layer.

In the above invention (Invention 1), when the adhesive strength of the pressure sensitive adhesive layer to soda lime glass is P1 (N/25 mm), and the adhesive strength of a re-formed pressure sensitive adhesive layer to soda lime glass is P2 (N/25 mm), wherein the re-formed pressure sensitive adhesive layer is formed from a pressure sensitive adhesive solution obtained by dissolving the pressure sensitive adhesive layer, the adhesive strength ratio of P2 to P1 (P2/P1) may be preferably 0.5 or more and less than 1.47 (Invention 2).

In the above invention (Invention 1, 2), when the mass per unit volume of the pressure sensitive adhesive layer is M1 (mg), and the mass of a pressure sensitive adhesive after filtrating through Tetoron mesh #200 and drying a pressure sensitive adhesive solution obtained by dissolving the pressure sensitive adhesive layer of the unit volume is M2 (mg), the mass ratio of M2 to M1 (M2/M1) may be preferably 0.7 or more (Invention 3).

Second, the present invention provides a pressure sensitive adhesive sheet comprising at least a pressure sensitive adhesive layer, wherein a pressure sensitive adhesive that constitutes the pressure sensitive adhesive layer contains a polymer having a main chain obtained by copolymerizing an acrylic-based monomer and a cyclodextrin derivative having a polymerizable group (Invention 4).

The pressure sensitive adhesive and pressure sensitive adhesive layer of the pressure sensitive adhesive sheet in the above invention (Invention 4) easily satisfy the physical properties of the previously described gel fraction and 500% modulus and are therefore excellent in the recyclability as described previously. Note, however, that the physical properties of the previously described gel fraction and 500% modulus may not have to be satisfied, provided that the desired recyclability can be obtained.

In the above invention (Invention 4), the polymerizable group possessed by the cyclodextrin derivative may be preferably a group that contains a polymerizable unsaturated double bond (Invention 5).

In the above invention (Invention 4, 5), the pressure sensitive adhesive may be preferably free from a guest molecule that can be included in the cyclodextrin derivative (Invention 6).

In the above invention (Invention 4 to 6), the weight-average molecular weight of a sol content of the pressure sensitive adhesive measured by a gel permeation chromatography method may be preferably 100,000 or more and 3,000,000 or less (Invention 7).

In the above invention (Invention 4 to 7), the glass-transition temperature (Tg) of the polymer may be preferably higher than −55° C. and 20° C. or lower (Invention 8).

In the above invention (Invention 1 to 8), the pressure sensitive adhesive sheet may preferably include two release sheets, and the pressure sensitive adhesive layer may be preferably interposed between the two release sheets so as to be in contact with release surfaces of the two release sheets (Invention 9).

Third, the present invention provides a method of manufacturing a pressure sensitive adhesive sheet comprising at least a pressure sensitive adhesive layer, the method comprising: forming a coating film by applying a pressure sensitive adhesive composition that contains an acrylic-based monomer and a cyclodextrin derivative having a polymerizable group; and forming a pressure sensitive adhesive layer by irradiating the coating film with an active energy ray to copolymerize the acrylic-based monomer and the cyclodextrin derivative (Invention 10).

### Advantageous Effect of the Invention

The pressure sensitive adhesive layer of the pressure sensitive adhesive sheet according to the present invention can be recycled. Moreover, according to the method of manufacturing a pressure sensitive adhesive sheet of the present invention, it is possible to manufacture a pressure sensitive adhesive sheet whose pressure sensitive adhesive layer can be recycled.

### BRIEF DESCRIPTION OF DRAWING(S)

FIG. 1 is a cross-sectional view of a pressure sensitive adhesive sheet according to an embodiment of the present invention.

### EMBODIMENTS FOR CARRYING OUT THE INVENTION

Hereinafter, one or more embodiments of the present invention will be described.

The pressure sensitive adhesive sheet according to an embodiment of the present invention includes at least a pressure sensitive adhesive layer. The gel fraction of a pressure sensitive adhesive that constitutes the pressure sensitive adhesive layer is preferably less than 10%, and the 500% modulus when performing a tensile test at 23° C. for the pressure sensitive adhesive layer is preferably 0.02 N/mm² or more and 5 N/mm² or less. Measurement methods for the gel fraction and 500% modulus in the present specification are as described in the testing examples, which will be described later.

The pressure sensitive adhesive layer having the above physical properties is excellent in the recyclability. For example, when a pressure sensitive adhesive is obtained through dissolving the pressure sensitive adhesive layer of the pressure sensitive adhesive sheet according to the present embodiment in a solvent or the like, filtrating the dissolved solution through a predetermined filtration membrane (e.g., Tetoron mesh #200), and drying the filtrate, the mass of the pressure sensitive adhesive after the drying does not decrease significantly from the mass of the original pressure sensitive adhesive, and the recoverability is excellent. This effect can be easily achieved particularly because the gel fraction is small as described above. The purpose of filtration with the filtration membrane is to remove lumps with large molecular weights that are not suitable for recycling. The pressure sensitive adhesive layer of the pressure sensitive adhesive sheet according to the present embodiment may be dissolved in a solvent or the like, and the pressure sensitive adhesive layer can be re-formed from the obtained pressure sensitive adhesive solution. The re-formed pressure sensitive adhesive layer can then exhibit an adhesive strength close to that of the original pressure sensitive adhesive layer. This effect can be easily achieved when the 500% modulus is relatively large and within a predetermined range regardless of the small gel fraction as above.

From the viewpoint of the above recyclability, the gel fraction of the above pressure sensitive adhesive may be preferably less than 10%, more preferably 9% or less, particularly preferably 8% or less, and further preferably 7% or less. On the other hand, the lower limit of the gel fraction is most preferably 0%, but in practice it may be preferably 1% or more, more preferably 2% or more, particularly preferably 3% or more, and further preferably, 3.7% or more.

Additionally or alternatively, from the viewpoint of the above recyclability, the 500% modulus of the above pressure sensitive adhesive layer may be preferably 0.02 N/mm² or more, more preferably 0.03 N/mm² or more, particularly preferably 0.06 N/mm² or more, and further preferably 0.08 N/mm² or more. Additionally or alternatively, the 500% modulus of the above pressure sensitive adhesive layer may be preferably 5 N/mm² or less, more preferably 2 N/mm² or less, particularly preferably 1 N/mm² or less, further preferably 0.5 N/mm² or less, and most preferably 0.2 N/mm² or less. This allows the pressure sensitive adhesive layer to be easily stretched to 500% or more, and the initial adhesive strength and re-formation adhesive strength, which will be described later, are improved.

If the recyclability related to the above recoverability is represented by physical properties, then, when the mass per unit volume of the pressure sensitive adhesive layer is M1 (mg), and the mass of a pressure sensitive adhesive after filtrating through Tetoron mesh #200 and drying a pressure sensitive adhesive solution obtained by dissolving the pressure sensitive adhesive layer of the unit volume is M2 (mg), the mass ratio of M2 to M1 (M2/M1) may be preferably 0.7 or more, particularly preferably 0.8 or more, and further preferably 0.9 or more. The upper limit of the mass ratio (M2/M1) is most preferably 1, but in practice it may be preferably 0.99 or less, particularly preferably 0.98 or less, and further preferably 0.97 or less. A specific measurement method for each mass is as described in the testing example, which will be described later.

If the recyclability related to the above adhesive strength is represented by physical properties, then, when the adhesive strength of the pressure sensitive adhesive layer to soda lime glass is P1 (N/25 mm), and the adhesive strength of a re-formed pressure sensitive adhesive layer, which is formed from a pressure sensitive adhesive solution obtained by dissolving the pressure sensitive adhesive layer in a solvent or the like, to soda lime glass is P2 (N/25 mm), the adhesive strength ratio of P2 to P1 (P2/P1) may be preferably 0.5 or more, more preferably 0.7 or more, particularly preferably 0.8 or more, further preferably 0.9 or more, and most preferably 0.95 or more. Additionally or alternatively, from the viewpoint of reworkability, the adhesive strength ratio (P2/P1) may be preferably less than 1.47, more preferably 1.4 or less, particularly preferably 1.2 or less, further preferably 1.1 or less, and most preferably 1.0 or less.

Here, the adhesive strength in the present specification refers basically to a peel strength that is measured using a method of 180° peeling in accordance with JIS Z0237: 2009. The peel strength shall be measured through preparing a measurement sample having a width of 25 mm and a length of 100 mm, attaching the measurement sample to an adherend, pressurizing the sample at 0.5 MPa and 50° C. for 20 minutes, then leaving the sample untouched under conditions of ordinal pressure, 23° C., and 50% RH for 24 hours, and after that performing the measurement at a peel speed of 300 mm/min.

The pressure sensitive adhesive sheet according to another embodiment of the present invention includes at least a pressure sensitive adhesive layer, and a pressure sensitive adhesive that constitutes the pressure sensitive adhesive layer preferably contains a polymer having a main chain obtained by copolymerizing an acrylic-based monomer and a cyclodextrin derivative having a polymerizable group. The pressure sensitive adhesive and pressure sensitive adhesive layer of such a pressure sensitive adhesive sheet easily satisfy the physical properties of the previously described gel fraction and 500% modulus and are therefore excellent in the recyclability as described previously. The above pressure sensitive adhesive may preferably satisfy the previously described gel fraction.

The above pressure sensitive adhesive may be preferably free from a guest molecule that can be included in the cyclodextrin derivative. In the present specification, inclusion refers to a phenomenon that a guest molecule is taken into a cavity possessed by a host molecule (cyclodextrin derivative). The guest molecule in the present specification refers to a molecule that can be included in the cyclodextrin derivative, and such molecules include those that have not yet been included the cyclodextrin derivative. Examples of such guest molecules include n-butyl acrylate, styrene, octyl acrylate, and dodecyl acrylate for α-cyclodextrin derivatives, n-butyl acrylate, t-butyl acrylate, styrene, adamantyl acrylate, and isobornyl acrylate for β-cyclodextrin derivatives, and octyl acrylate and dodecyl acrylate for γ-cyclodextrin derivatives.

In the present specification, the pressure sensitive adhesive being “free from a guest molecule that can be included in the cyclodextrin derivative” means that the pressure sensitive adhesive does not substantially contain a guest molecule that can be included in the cyclodextrin derivative. Specifically, it is allowed that the pressure sensitive adhesive may contain guest molecules in an amount of 1 mol or less, preferably 0.1 mol or less, particularly preferably 0.01 mol or less, and further preferably 0.001 mol or less with respect to the total amount of acrylic-based monomers of 100 mol. The above-listed monomers may be used as acrylic-based monomers, for example, but the monomers basically become polymers by polymerization and do not become guest molecules that can be included in the cyclodextrin derivative, while a small amount of guest molecules may remain even after the polymerization, so the definition is as the above.

The above polymer having a main chain obtained by copolymerizing the acrylic-based monomer and the cyclodextrin derivative having a polymerizable group preferably does not have a branched structure. In this case, the pressure sensitive adhesive obtained does not become unduly dense, and the previously described physical properties can be easily satisfied.

Preferably, the above pressure sensitive adhesive layer may be formed from a pressure sensitive adhesive composition that contains an acrylic-based monomer (A) and a cyclodextrin derivative (B) having a polymerizable group and preferably further contains a photopolymerization initiator (C) (the above pressure sensitive adhesive composition may be referred to as a “pressure sensitive adhesive composition P,” hereinafter). The polymer having a main chain obtained by copolymerizing the acrylic-based monomer (A) and the cyclodextrin derivative (B) may be referred to as a “polymer Q,” hereinafter.

### 1. Components

### (1) Acrylic-Based Monomer (A)

The acrylic-based monomer (A) in the present embodiment may be preferably a monofunctional acrylic-based monomer. In this case, the polymer Q of the acrylic-based monomer (A) and the cyclodextrin derivative (B) can have no branched structure, and the previously described physical properties can be easily satisfied.

Preferred examples of the acrylic-based monomer (A) in the present embodiment include (meth)acrylic ester, (meth)acrylic acid, (meth)acrylamide, vinyl acetate, and styrene. One type of the acrylic-based monomer (A) may be used alone or two or more types may also be used in combination. As used in the present specification, the term “(meth)acrylic acid” refers to both the acrylic acid and the methacrylic acid. The same applies to other similar terms.

Examples of the (meth)acrylic ester include (meth)acrylic alkyl ester having a linear or branched alkyl group, (meth)acrylic ester having a cyclic structure such as an alicyclic structure, and (meth)acrylic ester having a functional group such as a hydroxyl group.

From the viewpoint of pressure sensitive adhesive properties, the above (meth)acrylic alkyl ester may be preferably (meth)acrylic alkyl ester whose carbon number of alkyl group is 1 to 20. Examples of the (meth)acrylic alkyl ester whose carbon number of alkyl group is 1 to 20 include methyl (meth)acrylate, ethyl (meth)acrylate, propyl (meth)acrylate, n-butyl (meth)acrylate, n-pentyl (meth) acrylate, n-hexyl (meth)acrylate, 2-ethylhexyl (meth)acrylate, isooctyl (meth)acrylate, n-decyl (meth)acrylate, n-dodecyl (meth)acrylate, myristyl (meth)acrylate, palmityl (meth)acrylate, and stearyl (meth)acrylate. Among these, (meth)acrylic alkyl ester whose carbon number of alkyl group is 1 to 8 may be preferred, and methyl (meth)acrylate, ethyl (meth)acrylate, n-butyl (meth)acrylate, 2-ethylhexyl (meth)acrylate, etc. may be more preferred, from the viewpoint of improving the pressure sensitive adhesive properties. From the viewpoint of recyclability, methyl methacrylate, ethyl acrylate, n-butyl acrylate, 2-ethylhexyl acrylate, etc. may be particularly preferred. In the viewpoint that the pressure sensitive adhesive layer obtained easily satisfies the physical properties such as the above-described 500% modulus and adhesive strength ratio, preferred examples include ethyl acrylate and n-butyl acrylate.

The (meth)acrylic ester having a cyclic structure is bulky, so it is expected that the presence of such a (meth)acrylic ester in the polymer moderately increases the distance between the polymers. This allows the obtained pressure sensitive adhesive to be excellent in the flexibility while exhibiting cohesive properties, and the physical properties such as the above-described 500% modulus and adhesive strength ratio can be easily satisfied. From this viewpoint, among the (meth)acrylic esters having a cyclic structure, (meth)acrylic ester that includes an alicyclic structure may be particularly preferred, and such preferred examples include cyclohexyl (meth)acrylate, dicyclopentanyl (meth)acrylate, adamantyl (meth)acrylate, isobornyl (meth)acrylate, dicyclopentenyl (meth)acrylate, and dicyclopentenyloxyethyl (meth)acrylate. Among these, isobornyl (meth)acrylate may be preferred, and isobornyl acrylate may be particularly preferred, from the viewpoint that the obtained pressure sensitive adhesive layer easily satisfies the above-described physical properties.

Examples of (meth)acrylic ester having a functional group such as a hydroxyl group include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. Among these, 2-hydroxyethyl (meth)acrylate, 4-hydroxybutyl (meth)acrylate, etc. may be preferred and 2-hydroxyethyl acrylate, 4-hydroxybutyl acrylate, etc. may be particularly preferred, from the viewpoint that the obtained pressure sensitive adhesive layer easily satisfies the above-described physical properties.

From the viewpoint of pressure sensitive adhesive properties, it may be preferred to use, among the above, at least (meth)acrylic ester whose carbon number of alkyl group is 1 to 8. When the total amount of the acrylic-based monomer (A) is 100 mol, the compounding amount of the above (meth)acrylic ester whose carbon number of at least the alkyl group is 1 to 8 may be preferably 30 to 100 mol. When the (meth)acrylic ester having a functional group such as a hydroxyl group is used in combination as the acrylic-based monomer (A), the compounding amount of the above (meth)acrylic ester whose carbon number of at least the alkyl group is 1 to 8 may be more preferably 50 to 99 mol, particularly preferably 60 to 97 mol, further preferably 80 to 95 mol, and most preferably 90 to 94 mol. This allows the obtained pressure sensitive adhesive layer to more easily satisfy the above-described physical properties and exhibit good recyclability.

When the above-described (meth)acrylic ester having a cyclic structure is used as the acrylic-based monomer (A), it may be preferred to use in combination at least the above (meth)acrylic ester whose carbon number of alkyl group is 1 to 8. In this case, when the total amount of the acrylic-based monomer (A) is 100 mol, the compounding amount of the above (meth)acrylic ester having a cyclic structure may be preferably 1 to 30 mol, more preferably 2 to 20 mol, particularly preferably 3 to 10 mol, and further preferably 4 to 5 mol. This allows the obtained pressure sensitive adhesive layer to more easily satisfy the above-described physical properties and exhibit good recyclability.

When the above-described (meth)acrylic ester having a functional group such as a hydroxyl group is used as the acrylic-based monomer (A), it may be preferred to use in combination at least the above (meth)acrylic ester whose carbon number of alkyl group is 1 to 8. In this case, when the total amount of the acrylic-based monomer (A) is 100 mol, the compounding amount of the above (meth)acrylic ester having a functional group such as a hydroxyl group may be preferably 0.1 to 10 mol, more preferably 0.2 to 5 mol, particularly preferably 0.4 to 2 mol, and further preferably 0.6 to 1 mol. This allows the obtained pressure sensitive adhesive layer to more easily satisfy the above-described physical properties and exhibit good recyclability.

When (meth)acrylic acid is used as the acrylic-based monomer (A), it may be preferred to use in combination at least the above (meth)acrylic ester whose carbon number of alkyl group is 1 to 8. In this case, when the total amount of the acrylic-based monomer (A) is 100 mol, the compounding amount of the above (meth)acrylic acid may be preferably 0.1 to 20 mol, more preferably 1 to 18 mol, particularly preferably 5 to 14 mol, and further preferably 8 to 12 mol. This allows the obtained pressure sensitive adhesive layer to more easily satisfy the above-described physical properties and exhibit good recyclability.

### (2) Cyclodextrin Derivative (B)

The cyclodextrin portion of the cyclodextrin derivative (B) having a polymerizable group in the present embodiment may be preferably α-cyclodextrin, β-cyclodextrin, or γ-cyclodextrin and particularly preferably β-cyclodextrin or γ-cyclodextrin from the viewpoint of solvent solubility.

The polymerizable group possessed by the cyclodextrin derivative (B) is not particularly limited, provided that it can be polymerized with the acryloyl group of the above acrylic-based monomer (A), but may be preferably a group that contains a polymerizable unsaturated double bond and more preferably an ethylenically unsaturated group. Specifically, the polymerizable group may be preferably a (meth)acryloyl group, a vinyl group, an allyl group, or the like and particularly preferably a (meth)acryloyl group.

One polymerizable group possessed by the cyclodextrin derivative (B) may be preferably present in one cyclodextrin molecule. In this case, the polymer Q of the acrylic-based monomer (A) and the cyclodextrin derivative (B) can have no branched structure, and the previously described physical properties can be easily satisfied.

From the above viewpoint, the content of the cyclodextrin derivative having two or more polymerizable groups in one molecule in the pressure sensitive adhesive composition P may be preferably as low as possible. Specifically, the content may be preferably 0.1 mass % or less, particularly preferably 0.01 mass % or less, and further preferably 0.001 mass % or less.

The cyclodextrin derivative (B) in the present embodiment may be preferably a compound represented by the following formula (1).

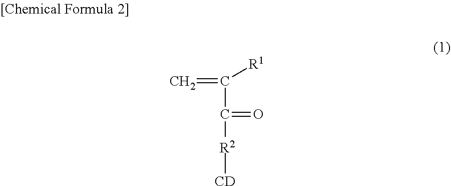

(R¹ in the above formula (1) represents a hydrogen atom or a methyl group. R² represents O, NH, or a hydrocarbon that contains NH. CD represents α-cyclodextrin, β-cyclodextrin or γ-cyclodextrin.)

Examples of the above “hydrocarbon that contains NH” include —CH₂—NH—CH₂—, —O—CH₂—NH—CH₂—, —CH₂—NH—CH₂—O—, —O—CH₂—NH—CH₂—O—, —CH₂—O—CO—NH—CH₂—O—, and —CH₂—O—CO—NH—C₂H₄—O—.

The mol ratio of the content of the cyclodextrin derivative (B) in the pressure sensitive adhesive composition P when the total amount of the acrylic-based monomer (A) is 100 mol may be preferably 0.01 or more, more preferably 0.1 or more, particularly preferably 0.5 or more, and further preferably 0.8 or more. When the upper limit of the content of the cyclodextrin derivative (B) is within the above range, the previously described physical properties are easily satisfied, and good pressure sensitive adhesive properties can be obtained. In particular, when the cyclodextrin portion of the cyclodextrin derivative (B) is γ-cyclodextrin, the above mol ratio may be preferably 1.2 or more, particularly preferably 1.5 or more, and further preferably 1.8 or more from the viewpoint that the 500% modulus of the obtained pressure sensitive adhesive layer can more easily satisfy the previously described value.

From another aspect, the mol ratio of the content of the cyclodextrin derivative (B) when the total amount of the acrylic-based monomer (A) is 100 mol may be preferably 10 or less, more preferably 7 or less, particularly preferably 4 or less, and further preferably 2 or less. When the content of the cyclodextrin derivative (B) is within the above range, the previously described physical properties are easily satisfied, and good pressure sensitive adhesive properties can be obtained. In particular, when the cyclodextrin portion of the cyclodextrin derivative (B) is β-cyclodextrin, the above mol ratio may be preferably 1.8 or less, particularly preferably 1.5 or less, and further preferably 1.2 or less from the viewpoint that the 500% modulus of the obtained pressure sensitive adhesive layer can more easily satisfy the previously described value.

When the mol ratio of the cyclodextrin derivative (B) with respect to the total amount of the acrylic-based monomer (A) of 100 mol is N and the thickness of the pressure sensitive adhesive layer is Z (μm), the value N×Z obtained by multiplying them may be preferably 22 to 1,000, more preferably 25 to 500, particularly preferably 28 to 100, and further preferably 30 to 60. This allows the 500% modulus of the obtained pressure sensitive adhesive layer to more easily satisfy the previously described value. Moreover, the desired adhesive strength can be easily exhibited.

### (3) Photopolymerization Initiator (C)

When ultraviolet rays are used as active energy rays for irradiation to copolymerize the acrylic-based monomer (A) and the cyclodextrin derivative (B) having a polymerizable group, the pressure sensitive adhesive composition P may preferably further contain a photopolymerization initiator (C). By containing the photopolymerization initiator (C) in this way, the acrylic-based monomer (A) can be efficiently copolymerized without remaining in the pressure sensitive adhesive, and the polymerization curing time and the amount of irradiation with active energy rays can be reduced.

Examples of such a photopolymerization initiator (C) include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylaminobenzoic ester, oligo[2-hydroxy-2-methyl-1-[4-(1-methylvinyl)phenyl] propanone], 2,4,6-trimethylbenzoyl-diphenyl-phosphine oxide, and bis(2,4,6-trimethylbenzoyl)-phenylphosphine oxide. These may each be used alone or two or more types may also be used in combination.

The mol ratio of the content of the photopolymerization initiator (C) in the pressure sensitive adhesive composition P when the total amount of the acrylic-based monomer (A) and the cyclodextrin derivative (B) is 100 mol may be preferably 0.001 to 10, more preferably 0.01 to 1, still more preferably 0.02 to 0.5, particularly preferably 0.05 to 0.3, and further preferably 0.1 to 0.2. This allows the obtained pressure sensitive adhesive layer to easily satisfy the previously described physical properties and exhibit good recyclability.

### (4) Various Additives

If desired, the pressure sensitive adhesive composition P can contain one or more of various additives, such as a silane coupling agent, an anticorrosive, an ultraviolet absorber, an antistatic, a tackifier, an antioxidant, a light stabilizer, a softening agent, a refractive index adjuster, and a filler, which are commonly used in an acrylic-based pressure sensitive adhesive.

### 2. Physical Properties

### (1) Weight-average Molecular Weight of Sol Content

The weight-average molecular weight of a sol content of the above pressure sensitive adhesive measured by a gel permeation chromatography method may be preferably 100,000 or more and 3,000,000 or less. This allows the pressure sensitive adhesive layer to easily satisfy the previously described physical properties and exhibit good recyclability. From this viewpoint, the weight-average molecular weight of the sol content may be more preferably 300,000 to 2,400,000, particularly preferably 600,000 to 1,800,000, further preferably 700,000 to 1,600,000, and most preferably 800,000 to 1,400,000. A specific measurement method for the weight-average molecular weight of the sol content is as described in the testing example, which will be described later.

### (2) Glass Transition Temperature (Tg)

The actual measured value of the glass transition temperature (Tg) of the above polymer Q may be preferably higher than −55° C. and 20° C. or lower. This allows the pressure sensitive adhesive layer to easily satisfy the previously described physical properties and exhibit good recyclability. From this viewpoint, the glass transition temperature (Tg) of the above polymer Q may be more preferably −50° C. to 10° C., still more preferably −45° C. to 0° C., particularly preferably −42° C. to −5° C., and further preferably −38° C. to −10° C. A measurement method for the glass-transition temperature (Tg) of the polymer is as described in the testing example, which will be described later.

### (3) Thickness of Pressure Sensitive Adhesive Layer

The thickness of the pressure sensitive adhesive layer in the pressure sensitive adhesive sheet according to the present embodiment (value measured in accordance with JIS K7130) may be preferably 1 μm or more, more preferably 4 μm or more, particularly preferably 10 μm or more, further preferably 18 μm or more, and most preferably 26 μm or more. This allows the desired adhesive strength to be exhibited. From another aspect, the thickness of the above pressure sensitive adhesive layer may be preferably 1,000 μm or less, more preferably 600 μm or less, and still more preferably 300 μm or less. From the viewpoint of improving the workability, the handling ability, the economic efficiency, etc., the thickness of the pressure sensitive adhesive layer may be preferably 200 μm or less, more preferably 100 μm or less, particularly preferably 85 μm or less, further preferably 55 μm or less, and most preferably 35 μm or less. The above pressure sensitive adhesive layer may be formed as a single layer or may also be formed by laminating a plurality of layers.

### (4) Adhesive Strength

The adhesive strength (initial adhesive strength) of the pressure sensitive adhesive layer in the pressure sensitive adhesive sheet according to the present embodiment to soda lime glass may be preferably 0.1 N/25 mm or more, more preferably 1 N/25 mm or more, particularly preferably 4 N/25 mm or more, further preferably 8 N/25 mm or more, and most preferably 12 N/25 mm or more. This allows the adherends to be brought into close contact with each other and fixed. From another aspect, the above adhesive strength (initial adhesive strength) may be preferably 100 N/25 mm or less, more preferably 75 N/25 mm or less, particularly preferably 50 N/25 mm or less, and further preferably 40 N/25 mm or less. This makes it possible to obtain reworkability that enables release from an adherend and re-adhesion to an adherend.

When a re-formed pressure sensitive adhesive layer is formed from a pressure sensitive adhesive solution that is obtained by dissolving in a solvent or the like the pressure sensitive adhesive layer in the pressure sensitive adhesive sheet according to the present embodiment, the adhesive strength of the re-formed pressure sensitive adhesive layer to soda lime glass (re-formation adhesive strength) may be preferably 0.1 N/25 mm or more, more preferably 1 N/25 mm or more, particularly preferably 4 N/25 mm or more, further preferably 8 N/25 mm or more, and most preferably 12 N/25 mm or more. This allows the adherends to be brought into close contact with each other and fixed again. From another aspect, the above adhesive strength (re-formation adhesive strength) may be preferably 100 N/25 mm or less, more preferably 75 N/25 mm or less, particularly preferably 50 N/25 mm or less, and further preferably 40 N/25 mm. This allows the reworkability to be obtained again.

### 3. Method of Manufacturing Pressure Sensitive Adhesive Sheet

To manufacture the pressure sensitive adhesive sheet according to the present embodiment, first, the pressure sensitive adhesive composition P may be preferably prepared. Specifically, the acrylic-based monomer (A) and the cyclodextrin derivative (B) are mixed and, if desired, the photopolymerization initiator (C), additives, etc. may be added to the mixture. Preferably, the pressure sensitive adhesive composition P may not contain a solvent (such as water or organic solvent).

Then, the pressure sensitive adhesive composition P may be applied to a desired object to form a coating film. Examples of the desired object include a desired base material in addition to the release sheets, which will be described later. The base material can be appropriately selected in accordance with the use of the pressure sensitive adhesive sheet. Examples of materials for the base material include a resin, glass, metal, and ceramics. The shape of the base material may be any of a film-like shape, a plate-like shape, a block-like shape, and the like. Examples of the resin include: polyesters such as polycarbonate, polyethylene terephthalate, polybutylene terephthalate, and polyethylene naphthalate; polyolefins such as polyethylene and polypropylene; cellulose such as triacetyl cellulose; polyvinyl chloride; polyvinylidene chloride; polyvinyl alcohol; ethylene-vinyl acetate copolymer; polyurethane; polystyrene; polyimide; polyetheretherketone; polyetherimide; polyethersulfone; polyphenylsulfone; polyphenylene sulfide; aramid; nylon; acrylic resin; norbornene-based resin; and cycloolefin resin.

Example of a method for use when applying the above pressure sensitive adhesive composition P include a bar coating method, a knife coating method, a roll coating method, a blade coating method, a die coating method, and a gravure coating method.

After the coating film of the pressure sensitive adhesive composition P is formed, the coating film is irradiated with active energy rays to copolymerize the acrylic-based monomer (A) and the cyclodextrin derivative (B) to form the pressure sensitive adhesive layer. One or more release sheets may be laminated on the pressure sensitive adhesive layer thus formed.

The active energy rays refer to electromagnetic wave or charged particle radiation having an energy quantum, and specific examples of the active energy rays include ultraviolet rays and electron rays. Among the active energy rays, ultraviolet rays may be particularly preferred because of easy management.

The irradiation with ultraviolet rays can be performed by using a high-pressure mercury lamp, a fusion H lamp, a xenon lamp, or the like. The irradiation amount as illuminance of ultraviolet rays may be preferably about 50 to 1,000 mW/cm² in an embodiment or about 100 to 500 mW/cm² in another embodiment. The light amount of ultraviolet rays may be preferably 50 to 10,000 mJ/cm², more preferably 200 to 7,000 mJ/cm², and particularly preferably 500 to 3,000 mJ/cm². On the other hand, the irradiation with electron rays can be performed with an electron ray accelerator or the like, and the irradiation amount of the electron rays may be preferably about 10 to 1,000 krad.

### 4. Form of Pressure Sensitive Adhesive Sheet

The pressure sensitive adhesive sheet according to the present embodiment may include at least the pressure sensitive adhesive layer, but it is preferred that a release sheet should be laminated on at least one surface of the pressure sensitive adhesive layer and it is also preferred that release sheets should be laminated on both surfaces of the pressure sensitive adhesive layer. Additionally or alternatively, the previously described base material may be laminated on one surface of the pressure sensitive adhesive layer.

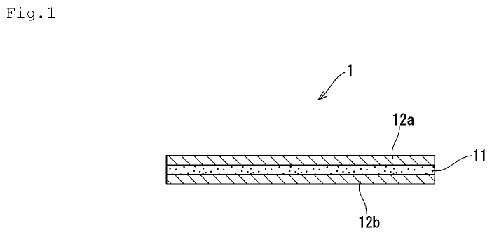

FIG. 1 illustrates a specific configuration as an example of the pressure sensitive adhesive sheet according to the present embodiment. As illustrated in FIG. 1, a pressure sensitive adhesive sheet 1 according to an embodiment is composed of two release sheets 12a and 12b and a pressure sensitive adhesive layer 11 that is interposed between the two release sheets 12a and 12b so as to be in contact with release surfaces of the two release sheets 12a and 12b. The release surface of a release sheet in the present specification refers to a surface having releasability in the release sheet, and examples of the release surface include both a surface subjected to release treatment and a surface that exhibits releasability even without being subjected to release treatment.

The pressure sensitive adhesive layer 11 is the pressure sensitive adhesive layer as described previously, and is preferably composed of a pressure sensitive adhesive obtained by curing the pressure sensitive adhesive composition P with active energy rays.

The release sheets 12a and 12b are to protect the pressure sensitive adhesive layer 11 until the use of the pressure sensitive adhesive sheet 1 and may be removed when using the pressure sensitive adhesive sheet 1 (pressure sensitive adhesive layer 11). In the pressure sensitive adhesive sheet 1 according to the present embodiment, one or both of the release sheets 12a and 12b may be unnecessary.

Examples of the release sheets 12a and 12b for use include polyethylene films, polypropylene films, polybutene films, polybutadiene films, polymethylpentene films, polyvinyl chloride films, vinyl chloride copolymer films, polyethylene terephthalate films, polyethylene naphthalate films, polybutylene terephthalate films, polyurethane films, ethylene vinyl acetate films, ionomer resin films, ethylene-(meth)acrylic acid copolymer films, ethylene-(meth)acrylic ester copolymer films, polystyrene films, polycarbonate films, polyimide films, and fluorine resin films. Crosslinked films thereof may also be used. Laminate films each obtained by laminating a plurality of such films may also be used.

It may be preferred to perform release treatment for the release surfaces (in particular, surfaces to be in contact with the pressure sensitive adhesive layer 11) of the release sheets 12a and 12b. Examples of a release agent to be used for the release treatment include alkyd-based, silicone-based, fluorine-based, unsaturated polyester-based, polyolefin-based, and wax-based release agents. One of the release sheets 12a and 12b may be preferably a tight release sheet that requires higher peeling force while the other may be preferably an easy release sheet that requires lower peeling force.

The thickness of the release sheets 12a and 12b is not particularly limited, but may be usually about 20 to 200 μm.

An exemplary method of manufacturing the pressure sensitive adhesive sheet 1 may include applying the pressure sensitive adhesive composition P to the release surface of one release sheet 12a (or 12b) to form a coating layer and then overlapping the release surface of the other release sheet 12b (or 12a) on the coating layer. Then, the coating layer of the pressure sensitive adhesive composition P is irradiated with active energy rays through one of the release sheets, and the coating layer is cured to form the pressure sensitive adhesive layer. The above pressure sensitive adhesive sheet 1 is thus obtained.

### 5. Applications

The pressure sensitive adhesive sheet according to the present embodiment can be preferably used for applications in fields in which recycling is possible. Examples of such applications include, but are not limited to, display bodies (displays), solar panels, semiconductor devices, batteries, mobile bodies (such as automobiles, railroad vehicles, ships, and flight vehicles), bonding between members in various devices/products such as glass scattering prevention members, wall decoration, labeling, workpiece processing applications for temporal attachment to workpieces such as semiconductors and grass for processing them, protective applications for attaching protective sheets that temporarily or continuously protect various members and products, applications for transportation of workpieces, and removal of foreign substances.

The embodiments heretofore explained are described to facilitate understanding of the present invention and are not described to limit the present invention. It is therefore intended that the elements disclosed in the above embodiments include all design changes and equivalents to fall within the technical scope of the present invention.

For example, one of the release sheets 12a and 12b in the pressure sensitive adhesive sheet 1 may be omitted.

In the present specification, unless otherwise specified, the statement of “X to Y” (X and Y are arbitrary numbers) encompasses not only the meaning of “X or more and Y or less” but also the meaning of “preferably more than X” or “preferably less than Y.” In addition, unless otherwise specified, the statement of “X or more” (X is an arbitrary number) encompasses the meaning of “preferably more than X,” and the statement of “Y or less” (Y is an arbitrary number) encompasses the meaning of “preferably less than Y.”

### EXAMPLES

Hereinafter, the present invention will be described further specifically with reference to examples, etc., but the scope of the present invention is not limited to these examples, etc.

### Example 1

### 1. Preparation of Coating Liquid for Pressure Sensitive Adhesive Composition

The pressure sensitive adhesive composition was obtained through mixing n-butyl acrylate and ethyl acrylate as the acrylic-based monomers (A), 6-acrylamide-β-cyclodextrin (B1) as the cyclodextrin derivative (B), and 1-hydroxycyclohexylphenyl ketone as the photopolymerization initiator (C) at the mol ratios listed in Table 1 and sufficiently stirring them.

The mol ratios listed in Table 1 represent a mol ratio when the total amount of the acrylic-based monomer (A) is 100 mol for each acrylic-based monomer (A), a mol ratio when the total amount of the acrylic-based monomer (A) is 100 mol for each cyclodextrin derivative (B), and a mol ratio when the total amount of the acrylic-based monomer (A) and the cyclodextrin derivative (B) is 100 mol for each photopolymerization initiator (C).

### 2. Manufacture of Pressure Sensitive Adhesive Sheet

The pressure sensitive adhesive composition obtained in the above step 1 was applied using a knife coater to the release-treated surface of a tight release sheet (available from LINTEC Corporation, product name “SP-PET752150”) to form a coating layer. The tight release sheet is a product obtained by release-treating one surface of a polyethylene terephthalate film with a silicone-based release agent.

Subsequently, the coating layer on the tight release sheet obtained as above and an easy release sheet (available from LINTEC Corporation, product name “SP-PET381031”) were bonded to each other so that the release-treated surface of the easy release sheet was in contact with the coating layer. The easy release sheet is a product obtained by release-treating one surface of a polyethylene terephthalate film with a silicone-based release agent.

After that, the coating layer was irradiated with active energy rays (ultraviolet rays; UV) under the following conditions through the easy release sheet to cure the coating layer into the pressure sensitive adhesive layer having a thickness of 30 μm. Thus, the pressure sensitive adhesive sheet having a configuration of tight release sheet/pressure sensitive adhesive layer (thickness: 30 μm)/easy release sheet was produced.

### <<Ultraviolet Irradiation Conditions>>

Using a high-pressure mercury lamp
Illuminance of 200 mW/cm² and light amount of 2,000 mJ/cm²
Using “UVPF-A1” available from EYE GRAPHICS CO., LTD. as a UV illuminance/light amount meter

The thickness of the above pressure sensitive adhesive layer is a value measured using a constant-pressure thickness meter (available from TECLOCK Co., Ltd., product name “PG-02”) in accordance with JIS K7130 (here and hereinafter).

### Examples 2 to 4 and Comparative Examples 1 to 3

Pressure sensitive adhesive sheets were manufactured in the same manner as in Example 1 except that the type and compounding amount of the acrylic-based monomer (A), the type and compounding amount of the cyclodextrin derivative (B), the compounding amount of the photopolymerization initiator (C), and the thickness of the pressure sensitive adhesive layer were as listed in Table 1.

Details of the simplified names listed in Table 1 and additional information are as follows.

### <Acrylic-Based Monomer (A)>

BA: n-butyl acrylate
EA: ethyl acrylate
AA: acrylic acid
MMA: methyl methacrylate
IBXA: isobornyl acrylate
4HBA: 4-hydroxybutyl acrylate
DCP: dicyclopentadiene (For descriptive purposes, it is listed in the column of the acrylic-based monomer (A).)

### <Cyclodextrin Derivative (B)>

B1: 6-acrylamide-β-cyclodextrin
B2: 6-acrylamide-γ-cyclodextrin
B3: di(2-isocyanatoethyl acrylate)-O-cyclodextrin

Here, N×Z was calculated, where N is the number of moles of the cyclodextrin derivative (B) used in Examples and Comparative Examples, and Z (μm) is the thickness of the pressure sensitive adhesive layer. The results are listed in Table 1.

### <Testing Example 1> (Measurement of gel fraction)

The pressure sensitive adhesive sheet obtained in each of Examples and Comparative Examples was cut into a size of 80 mm×80 mm, the pressure sensitive adhesive layer was wrapped in a polyester mesh (mesh size of 200), the mass was weighed with a precision balance, and the mass of the pressure sensitive adhesive alone was calculated by subtracting the mass of the above mesh itself. The mass at that time is M1.

Then, the pressure sensitive adhesive wrapped in the above polyester mesh was immersed in ethyl acetate at room temperature (23° C.) for 24 hours. After that, the pressure sensitive adhesive was taken out, air-dried under an environment of a temperature of 23° C. and a relative humidity of 50% for 24 hours, and further dried in an oven at 80° C. for 12 hours. After the drying, the mass was weighed with a precision balance, and the mass of the pressure sensitive adhesive alone was calculated by subtracting the mass of the above mesh itself. The mass at that time is M2. The gel fraction (%) is represented by (M2/M1)×100. Through this operation, the gel fraction of the pressure sensitive adhesive was derived. The results are listed in Table 2.

### <Testing Example 2> (Measurement of Molecular Weight of Sol Content)

The sol content was obtained by concentrating the ethyl acetate used in the measurement of the gel fraction in Testing Example 1 with an evaporator. Then, the sol content was diluted with tetrahydrofuran to a 0.5 mass % solution, and the weight-average molecular weight (Mw) was measured.

The results are listed in Table 2.

The above weight-average molecular weight (Mw) refers to a weight-average molecular weight that is measured as a polystyrene equivalent value under the following conditions using gel permeation chromatography (GPC) (GPC measurement).

### <<Measurement Conditions>>

GPC measurement device: HLC-8020 available from Tosoh Corporation
GPC columns (passing through in the following order): available from Tosoh Corporation
   TSK guard column HXL-H
   TSK gel GMHXL (×2)
   TSK gel G2000HXL
Solvent for measurement: tetrahydrofuran
Measurement temperature: 40° C.

### <Testing Example 3> (Measurement of Glass-Transition Temperature (Tg))

A plurality of the pressure sensitive adhesive layers of the pressure sensitive adhesive sheets produced in each of Examples and Comparative Examples were laminated to form a laminate so that the thickness would be 0.8 mm. A cylindrical body (height of 0.8 mm) having a diameter of 8 mm was punched out from the obtained laminate of the pressure sensitive adhesive layers, and this was used as a sample.

For the above sample, the loss tangent was measured by a torsional shear method in accordance with JIS K7244-1 using a dynamic viscoelasticity measurement device (available from Anton Paar, product name “MCR 301”) under the following conditions. Then, the glass-transition temperature (Tg) of the pressure sensitive adhesive (polymer) prepared in each of Examples and Comparative Examples was calculated from the local maximum value of the loss tangent. The results are listed in Table 2.
Measurement frequency: 1 Hz
Measurement temperature range: −60° C. to 80° C.
Heating rate: 5° C./min

### <Testing Example 4> (Measurement of 500% Modulus)

After laminating a plurality of pressure sensitive adhesive layers of the pressure sensitive adhesive sheets obtained in each of Examples and Comparative Examples to a total thickness of 600 μm, a sample of 10 mm width×75 mm length was cut out. The above sample was set in a tensile tester (available from ORIENTEC Co., LTD., product name “TENSILON”) so that the sample measurement site would be 10 mm width×20 mm length (stretching direction), and stretched at a tensile speed of 200 mm/min under an environment of 23° C. and 50% RH using the tensile tester, and the stress value at which the stretch ratio was 500% was measured as a 500% modulus (N/mm²). The results are listed in Table 2. Note that Comparative Example 3 was broken midway the measurement.

### <Testing Example 5> (Measurement of Adhesive Strength)

The easy release sheet was removed from the pressure sensitive adhesive sheet obtained in each of Examples and Comparative Examples, and the exposed pressure sensitive adhesive layer was bonded to the easy-adhesion layer of a polyethylene terephthalate (PET) film having the easy-adhesion layer (available from TOYOBO CO., LTD., product name “PET50 A4360,” thickness: 50 μm) to obtain a laminate of tight release sheet/pressure sensitive adhesive layer/PET film. The laminate thus obtained was cut into a width of 25 mm and a length of 100 mm.

The tight release sheet was removed from the above laminate under an environment of 23° C. and 50% RH, and the exposed pressure sensitive adhesive layer was bonded to soda lime glass (available from Nippon Sheet Glass Company, Ltd.) and then pressurized in an autoclave available from KURIHARA SEISAKUSHO Co., Ltd. at 0.5 MPa and 50° C. for 20 minutes. After that, the pressure sensitive adhesive layer with the soda lime glass was left untouched under a condition of 23° C. and 50% RH for 24 hours, and this was used as a sample. Then, the adhesive strength (initial adhesive strength (P1); N/25 mm) was measured under conditions of a peel speed of 300 mm/min and a peel angle of 180° by using a tensile tester (available from ORIENTEC Co., LTD., product name “TENSILON”). The measurement was conducted in accordance with JIS Z0237: 2009 except for the conditions described herein. The results are listed in Table 2.

Then, the pressure sensitive adhesive layer of the pressure sensitive adhesive sheet obtained in each of Examples and Comparative Examples was dissolved in ethyl acetate, and the solid concentration was adjusted to 30 mass %. The pressure sensitive adhesive solution thus obtained was filtrated through Tetoron mesh #200. After that, the filtrate was applied using a knife coater to the release-treated surface of the same tight release sheet as the previously described tight release sheet and then subjected to heat treatment at 90° C. for 1 minute to form a re-formed pressure sensitive adhesive layer.

Then, the re-formed pressure sensitive adhesive layer on the tight release sheet thus obtained above was bonded to the easy-adhesion layer of a polyethylene terephthalate (PET) film having the easy-adhesion layer (available from TOYOBO CO., LTD., product name “PET50 A4360,” thickness: 50 μm) to obtain a laminate of tight release sheet/re-formed pressure sensitive adhesive layer/PET film. Using this laminate, the adhesive strength of the re-formed pressure sensitive adhesive layer (re-formation adhesive strength (P2); N/25 mm) was measured in the same manner as above. The results are listed in Table 2.

On the basis of the above measurement results, the adhesive strength ratio (P2/P1) of the re-formation adhesive strength (P2) to the initial adhesive strength (P1) was calculated. The results are listed in Table 2.

### <Testing Example 6> (Evaluation of Reworkability)

In measuring the initial adhesive strength in Testing Example 5, when the laminate of the PET film and the pressure sensitive adhesive layer was peeled off from the soda lime glass, the presence or absence of a phenomenon that the pressure sensitive adhesive remained on the soda lime glass (so-called adhesive residue) was visually confirmed, and the reworkability was evaluated based on the following criteria. The results are listed in Table 2.
A . . . The pressure sensitive adhesive did not remain at all.
B . . . The pressure sensitive adhesive remained partially.
C . . . The pressure sensitive adhesive remained on the whole.

### <Testing Example 7> (Evaluation of Re-Formability)

In Testing Example 5, whether or not the re-formed pressure sensitive adhesive layer was able to be formed well was visually determined, and the re-formability was evaluated based on the following criteria. The results are listed in Table 2.
B . . . The re-formed pressure sensitive adhesive layer was able to be formed well.
C . . . The re-formed pressure sensitive adhesive layer was not able to be formed well.

For Comparative Examples 1 and 3 in which the re-formability of the pressure sensitive adhesive layer was evaluated as C, the measurement of the re-formation adhesive strength in Testing Example 5 was not able to be performed.

### <Testing Example 8> (Derivation of Pressure Sensitive Adhesive Mass Ratio)

The mass per 50 mm³ of the pressure sensitive adhesive layer of the pressure sensitive adhesive sheet obtained in each of Examples and Comparative Examples (initial pressure sensitive adhesive mass (M1); mg) was measured. Then, the 50 mm³ pressure sensitive adhesive layer was dissolved in ethyl acetate, the obtained pressure sensitive adhesive solution was filtrated through Tetoron mesh #200, and after that the filtrate was completely dried. The mass of the pressure sensitive adhesive thus recovered (recovered pressure sensitive adhesive mass (M2); mg) was measured. On the basis of the above measurement results, the mass ratio (M2/M1) of the recovered pressure sensitive adhesive mass (M2) to the initial pressure sensitive adhesive mass (M1) was calculated. The results are listed in Table 2. When the mass ratio (M2/M1) is 0.7 or more, it can be said that the recoverability of the pressure sensitive adhesive is excellent.

### <Testing Example 9> (Evaluation of Immersion Solubility)

The easy release sheet was removed from the pressure sensitive adhesive sheet obtained in each of Examples and Comparative Examples, the exposed pressure sensitive adhesive layer was bonded to the easy-adhesion layer of a polyethylene terephthalate (PET) film having the easy-adhesion layer (available from TOYOBO CO., LTD., product name “PET50 A4360,” thickness: 50 μm), and then the tight release sheet was removed. The laminate of pressure sensitive adhesive layer/PET film thus obtained was cut into a size of 25 mm×100 mm and this was used as a sample.

After the obtained sample was immersed in ethyl acetate for 72 hours, it was taken out, and the presence or absence of the pressure sensitive adhesive on the PET film of the sample on the pressure sensitive adhesive layer side was checked with a finger and visually. Then, the immersion solubility of the pressure sensitive adhesive layer was evaluated in accordance with the following criteria. The results are listed in Table 2.
A . . . It was not sticky.
B . . . It was sticky, but residual pressure sensitive adhesive was not visually observed.
C . . . Residual pressure sensitive adhesive was visually observed.

TABLE 1

| | | | | | | | | | | | Photopolymerization | Thickness of | |
|---|---|---|---|---|---|---|---|---|---|---|---|---|---|
| | Acrylic-based monomer (A) | | | | | | | Cyclodextrin derivative (B) | | | initiator (c) | pressure sensitive | |
| | [mol ratio] (in (A)100 mol) | | | | | | | [mol ratio] (for (A)100 mol) | | | [mol ratio] (for | adhesive layer | |
| | BA | EA | AA | MMA | IBXA | 4HBA | DCP | B1 | B2 | B3 | (A) + (B)100 mol) | Z[μm] | N × Z |
| Example 1 | 50 | 50 | — | — | — | — | — | 1 | — | — | 0.2 | 30 | 30 |
| Example 2 | 94 | — | — | — | 5 | 1 | — | — | 1 | — | 0.1 | 50 | 50 |
| Example 3 | 94 | — | — | — | 5 | 1 | — | — | 2 | — | 0.1 | 30 | 60 |
| Example 4 | 78 | — | 10 | 10 | — | 2 | — | 1 | — | — | 0.3 | 30 | 30 |
| Comparative | 100 | — | — | — | — | — | — | — | — | 0.7 | 0.2 | 30 | 21 |
| Example 1 | | | | | | | | | | | | | |
| Comparative | 50 | 50 | — | — | — | — | — | — | — | — | 0.2 | 30 | — |
| Example 2 | | | | | | | | | | | | | |
| Comparative | 40 | 50 | — | — | — | — | 1 | — | — | — | 0.2 | 30 | — |
| Example 3 | | | | | | | | | | | | | |

TABLE 2

| | | | | | Adhesive strength | | | Mass of pressure | | | | | |
|---|---|---|---|---|---|---|---|---|---|---|---|---|---|
| | | | | | | Re- | Adhesive | sensitive adhesive | | | | | |
| | Gel | Sol | | 500% | Initial | formation | strength | Initial | Recovered | | Re- | Re- | |
| | fraction | content | Tg | modulus | (P1) | (P2) | ratio | (M1) | (M2) | Mass | work- | form- | Immersion |
| | [%] | Mw | [° C.] | [N/mm²] | [N/25 mm] | [N/25 mm] | (P2/P1) | [mg] | [mg] | ratio | ability | ability | solubility |
| Example 1 | 6.8 | 870k | −12 | 0.088 | 38.1 | 37.5 | 0.98 | 53.00 | 49.40 | 0.93 | A | B | A |
| Example 2 | 3.8 | 1030k | −36 | 0.061 | 35.0 | 36.3 | 1.04 | 52.00 | 50.02 | 0.96 | B | B | A |
| Example 3 | 3.7 | 1370k | −31 | 0.139 | 13.0 | 12.8 | 0.98 | 53.00 | 51.04 | 0.96 | A | B | A |
| Example 4 | 3.6 | 950k | −30 | 0.032 | 23.4 | 21.5 | 0.92 | 52.00 | 50.13 | 0.96 | B | B | A |
| Comparative | 62.8 | 95k | −28 | 0.249 | 6.7 | — | — | 50.00 | 18.60 | 0.37 | B | C | C |
| Example 1 | | | | | | | | | | | | | |
| Comparative | 5.0 | 620k | −25 | 0.012 | 1.7 | 2.5 | 1.47 | 53.00 | 50.35 | 0.95 | C | B | B |
| Example 2 | | | | | | | | | | | | | |
| Comparative | 99.5 | 11k | −24 | Broken | 0.2 | — | — | 53.00 | 0.27 | 0.01 | A | C | C |
| Example 3 | | | | | | | | | | | | | |

It has been found from Table 2 that the pressure sensitive adhesive layers of the pressure sensitive adhesive sheets manufactured in Examples exhibit high recoverability, the adhesive strength of the re-formed pressure sensitive adhesive layer shows a value close to the adhesive strength of the initial pressure sensitive adhesive layer, and the pressure sensitive adhesive layer is thus excellent in the recyclability. Moreover, the pressure sensitive adhesive layers of the pressure sensitive adhesive sheets manufactured in Examples exhibit good reworkability and immersion solubility, and thus are excellent in the recyclability also from such a viewpoint.

### INDUSTRIAL APPLICABILITY

The pressure sensitive adhesive sheet according to the present invention can be suitably used for products that are desired to be recycled.

### DESCRIPTION OF REFERENCE NUMERALS

1 Pressure sensitive adhesive sheet
11 Pressure sensitive adhesive layer
12a, 12b Release sheet

1. A pressure sensitive adhesive sheet comprising at least a pressure sensitive adhesive layer, wherein
a gel fraction of a pressure sensitive adhesive that constitutes the pressure sensitive adhesive layer is less than 10%, and
a 500% modulus when performing a tensile test at 23° C. for the pressure sensitive adhesive layer is 0.02 N/mm² or more and 5 N/mm² or less.

2. The pressure sensitive adhesive sheet according to claim 1, wherein
when an adhesive strength of the pressure sensitive adhesive layer to soda lime glass is P1 (N/25 mm), and
an adhesive strength of a re-formed pressure sensitive adhesive layer to soda lime glass is P2 (N/25 mm), the re-formed pressure sensitive adhesive layer being formed from a pressure sensitive adhesive solution obtained by dissolving the pressure sensitive adhesive layer,
an adhesive strength ratio of P2 to P1 (P2/P1) is 0.5 or more and less than 1.47.

3. The pressure sensitive adhesive sheet according to claim 1, wherein
when a mass per unit volume of the pressure sensitive adhesive layer is M1 (mg), and
a mass of a pressure sensitive adhesive after filtrating through Tetoron mesh #200 and drying a pressure sensitive adhesive solution obtained by dissolving the pressure sensitive adhesive layer of the unit volume is M2 (mg),
a mass ratio of M2 to M1 (M2/M1) is 0.7 or more.

4. A pressure sensitive adhesive sheet comprising at least a pressure sensitive adhesive layer, wherein
a pressure sensitive adhesive that constitutes the pressure sensitive adhesive layer contains a polymer having a main chain obtained by copolymerizing an acrylic-based monomer and a cyclodextrin derivative having a polymerizable group.

5. The pressure sensitive adhesive sheet according to claim 4, wherein the polymerizable group possessed by the cyclodextrin derivative is a group that contains a polymerizable unsaturated double bond.

6. The pressure sensitive adhesive sheet according to claim 4, wherein the pressure sensitive adhesive is free from a guest molecule that can be included in the cyclodextrin derivative.

7. The pressure sensitive adhesive sheet according to claim 4, wherein a weight-average molecular weight of a sol content of the pressure sensitive adhesive measured by a gel permeation chromatography method is 100,000 or more and 3,000,000 or less.

8. The pressure sensitive adhesive sheet according to claim 4, wherein a glass-transition temperature (Tg) of the polymer is higher than −55° C. and 20° C. or lower.

9. The pressure sensitive adhesive sheet according to claim 1, wherein
the pressure sensitive adhesive sheet includes two release sheets, and
the pressure sensitive adhesive layer is interposed between the two release sheets so as to be in contact with release surfaces of the two release sheets.

10. A method of manufacturing a pressure sensitive adhesive sheet comprising at least a pressure sensitive adhesive layer, the method comprising:
forming a coating film by applying a pressure sensitive adhesive composition that contains an acrylic-based monomer and a cyclodextrin derivative having a polymerizable group; and
forming a pressure sensitive adhesive layer by irradiating the coating film with an active energy ray to copolymerize the acrylic-based monomer and the cyclodextrin derivative.
